(19) United States
(12) Patent Application Publication
(10) Pub. No.: US 2016/0153419 A1
(43) Pub. Date: Jun. 2, 2016

(54) Hybrid Vehicle

(71) Applicant: TOYOTA JIDOSHA KABUSHIKI KAISHA, Toyota-shi (JP)

(72) Inventor: Shinichiro MINEGISHI, Toyota-shi (JP)

(73) Assignee: TOYOTA JIDOSHA KABUSHIKI KAISHA, Toyota-shi (JP)

(21) Appl. No.: 14/955,376

(22) Filed: Dec. 1, 2015

(30) Foreign Application Priority Data
Dec. 2, 2014 (JP) 2014-244474

(51) Int. Cl. F02N 11/08; B60K 6/28; B60K 6/26; B60W 30/182; B60W 10/08; B60W 10/26; B60W 20/20; B60W 20/40; B60K 6/365; B60W 10/06

(52) U.S. Cl. CPC F02N 11/0866; B60K 6/365; B60K 6/28; B60K 6/26; B60W 10/06; B60W 10/08; B60W 10/26; B60W 20/20; B60W 20/40; B60W 30/182; Y10S 903/93; Y10S 903/91; Y10S 903/907; B60K 2006/268; B60Y 2200/92; B60Y 2300/182; B60Y 2300/63; B60Y 2400/11; B60Y 2400/73

(57) ABSTRACT

In the case where motors MG1 and MG2 are disconnected from a battery by a system main relay during stop of operation of an engine, the engine and the motor MG1 are controlled to cause the engine to be cranked and started by the motor MG1 (steps S250 and S270 to S290), while the motor MG2 is controlled to make a voltage VH of driving-voltage system power lines (capacitor) approach a target voltage VH* (steps S120 and S260).

### TECHNICAL FIELD

The present invention relates to a hybrid vehicle and more specifically a hybrid vehicle equipped with an engine, a planetary gear, first and second motors, a battery, a capacitor and a relay.

### BACKGROUND ART

A proposed configuration of a hybrid vehicle includes an engine, a planetary gear, a first motor, a second motor, a battery, a capacitor and an SMR (system main relay) (for example, JP 2012-153221A). A rotor of the first motor is connected with a sun gear of the planetary gear. A crankshaft of the engine is connected with a carrier of the planetary gear. A driveshaft linked with drive wheels is connected with a ring gear of the planetary gear. A rotor of the second motor is connected with the driveshaft. The capacitor is mounted to power lines connecting the first and the second motors with the battery. The relay is provided on the battery side of the capacitor on the power lines. In the case where an abnormality occurs in the battery, the hybrid vehicle of this configuration turns off the SMR and shifts to a battery-less drive. The battery-less drive first sets output torques (power control torques) of the first motor and the second motor, such as to control a voltage of the power lines to a voltage command value. The battery-less drive subsequently sets an allowable torque range of a drive torque that is output to the driveshaft, based on torque ranges of the first motor and the second motor set to allow for output of the power control torque. The battery-less drive then sets torque command values of the first motor and the second motor such as to cause a torque closest to a required torque within the allowable torque range to be output to the driveshaft, and controls the first and the second motors with these torque command values. Such control ensures the required torque for driving the hybrid vehicle, while controlling a DC voltage used for driving the first motor and the second motor to a fixed value.

### SUMMARY OF INVENTION

### Technical Problem

In the case where the SMR is turned off during stop of operation of the engine, however, the proposed configuration of the hybrid vehicle described above fails to control the DC voltage for driving the first motor and the second motor to a fixed value and thereby fails to sufficiently continue driving. There is accordingly a need to start and operate the engine in this case.

An object of the invention is to enable an engine of a hybrid vehicle to be started in the state that a first motor and a second motor are disconnected from a battery by a relay during stop of operation of the engine.

### Solution to Problem

In order to achieve the above primary object, the hybrid vehicle of the invention employs the following configuration.

The present invention is directed to a hybrid vehicle. The hybrid vehicle includes an engine, a first motor that is configured to input and output power, a planetary gear that is configured to have three rotational elements connected with a rotating shaft of the first motor, an output shaft of the engine and a driveshaft linked with drive wheels such that the rotating shaft, the output shaft and the drive shaft are arrayed in this sequence on a collinear diagram, a second motor that is configured to input and output power to and from the driveshaft, a battery, a capacitor that is mounted to power lines connecting the first motor and the second motor with the battery, a relay that is provided on a battery side of the capacitor on the power lines, and a controller that is configured to control the engine, the first motor and the second motor such that the hybrid vehicle is driven with a required torque in a state that the first motor and the second motor are connected with the battery by the relay. In a battery-less state that the first motor and the second motor are disconnected from the battery by the relay during stop of operation of the engine, the controller performs specified start control that controls the engine and the first motor to cause the engine to be cranked and started by the first motor, while controlling the second motor to make a voltage of the capacitor approach a target voltage.

The hybrid vehicle of this aspect controls the engine, the first motor and the second motor to enable the hybrid vehicle to be driven with the required torque in the state that the first motor and the second motor are connected with the battery by the relay. In the battery-less state that the first motor and the second motor are disconnected from the battery by the relay daring stop of operation of the engine, the hybrid vehicle of this aspect performs the specified start control. The specified start control herein controls the engine and the first motor to cause the engine to be cranked and started by the first motor, while controlling the second motor to make the voltage of the capacitor approach the target voltage. Performing the specified start control enables the engine to be cranked and started by the first motor (to start driving), while causing the voltage of the capacitor to be varied in a range close to the target voltage.

### BRIEF DESCRIPTION OF DRAWINGS

FIG. 1 is a configuration diagram illustrating the schematic configuration of a hybrid vehicle according to one embodiment of the invention;

FIG. 2 is a configuration diagram illustrating the schematic configuration of an electrical drive system including motors MG1 and MG2;

FIG. 3 is a flowchart showing one example of battery-less control routine performed by an RVECU according to the embodiment;

FIG. 4 is a diagram illustrating one example of required torque setting map;

FIG. 5 is a collinear diagram illustrating one example of dynamic relationship between rotation speed and torque with regard to rotational elements of a planetary gear; and

FIG. 6 is a diagram schematically illustrating time changes in torques Tm1 and Tm2 of the motors MG1 and MG2 and voltage VH of driving-voltage system power lines in the case of a shift to a battery-less state during stop of operation of an engine.

### DESCRIPTION OF EMBODIMENTS

The following describes some aspects of the invention with reference to embodiments,

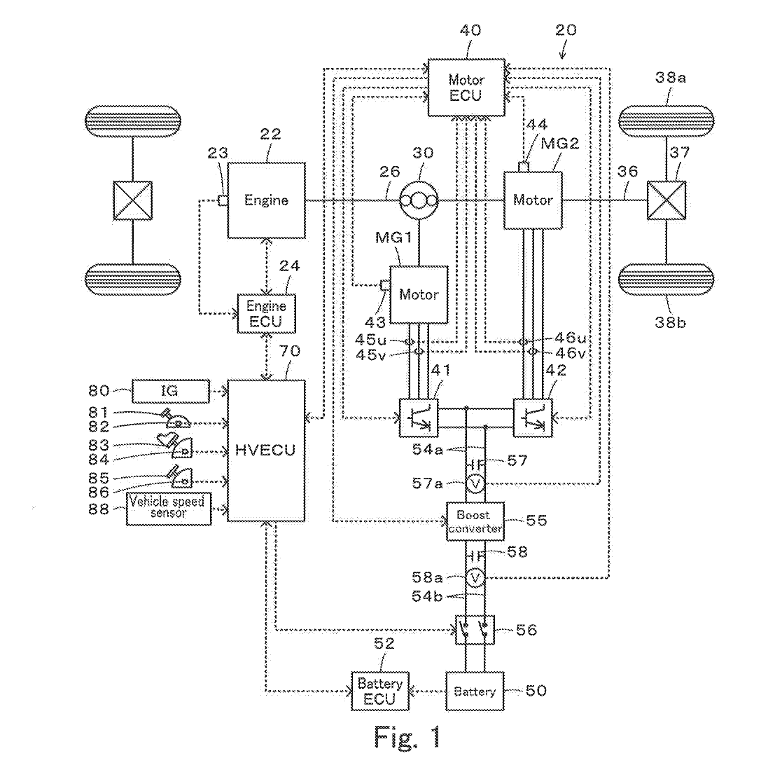

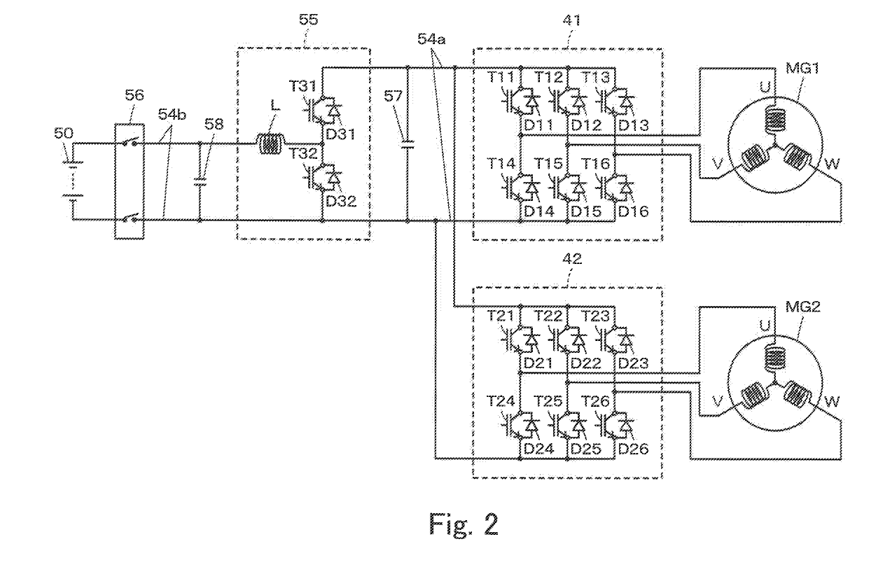

FIG. 1 is a configuration diagram illustrating the schematic configuration of a hybrid vehicle 20 according to one embodiment of the invention. FIG. 2 is a configuration diagram illustrating the schematic configuration of an electrical drive system including motors MG1 and MG2. As shown in FIG. 1, the hybrid vehicle 20 of the embodiment includes an engine 22, a planetary gear 30, motors MG1 and MG2, inverters 41 and 42, a boost converter 55, a battery 50, a system main relay 56 and a hybrid electronic control unit (hereinafter referred to as HVECU) 70.

The engine 22 is configured as an internal combustion engine that output power using, for example, gasoline or light oil as fuel. This engine 22 is operated and controlled by an engine electronic control unit (hereinafter referred to as engine ECU) 24.

The engine ECU 24 is implemented by a CPU-based microprocessor and includes a ROM that stores processing programs, a RAM that temporarily stores data, input and output ports and a communication port other than the CPU, although not being illustrated. The engine ECU 24 inputs, via its input port, signals from various sensors required for operation control of the engine 22, for example, a crank position θcr from a crank position sensor 23 configured to detect the rotational position of a crankshaft 26. The engine ECU 24 outputs, via its output port, various control signals for operation control of the engine 22, for example, a drive signal to a throttle motor configured to adjust the position of a throttle valve, a drive signal to a fuel injection valve and a control signal to an ignition coil integrated with an igniter. The engine ECU 24 is connected with the HVECU 70 via their communication ports to perform operation control of the engine 22 in response to control signals from the HVECU 70 and output data regarding the operating conditions of the engine 22 to the HVECU 70 as appropriate. The engine ECU 24 computes the rotation speed of the crankshaft 26, which is equal to a rotation speed Ne of the engine 22, based on the crank position Gcr detected by the crank position sensor 23.

The planetary gear 30 is configured as a single pinion-type planetary gear mechanism. The planetary gear 30 includes a sun gear that is connected with a rotor of the motor MG1. The planetary gear 30 also includes a ring gear that is connected with a driveshaft 36 linked with drive wheels 38a and 38b via a differential gear 37. The planetary gear 30 also includes a carrier that is connected with the crankshaft 26 of the engine 22.

The motor MG1 is configured as a synchronous motor generator including a rotor with permanent magnets embedded therein and a stator with three-phase coils wound thereon. The rotor of the motor MG1 is connected with the sun gear of the planetary gear 30 as described above. The motor MG2 is also configured as a synchronous motor generator like the motor MG1 and has a rotor connected with the driveshaft 36.

As shown in FIGS. 1 and 2, the inverter 41 is connected with driving-voltage system power lines 54a. The inverter 41 includes six transistors T11 to T16 and six diodes D11 to D16 that are connected reversely in parallel to the transistors T11 to T16. The transistors T11 to T16 are arranged in pairs as the source and the sink relative to a positive bus bar and a negative bus bar of the driving-voltage system power lines 54a, The three-phase coils (U phase, V phase and W phase) of the motor MG1 are respectively connected with respective junction points of the three paired transistors in the transistors T11 to T16, The ratio of the on time of the respective paired transistors in the transistors T11 to T16 is regulated by a motor electronic control unit (hereinafter referred to as motor ECU) 40 under application of a voltage to the inverter 41. This forms a rotating magnetic field in the three-phase coils to rotate and drive the motor MG1.

Like the inverter 41, the inverter 42 has six transistors T21 to T26 and six diodes D21 to D26. The ratio of the on time of the respective paired transistors in the transistors T21 to T26 is regulated by the motor ECU 40 under application of a voltage to the inverter 42. This forms a rotating magnetic field in the three-phase coils to rotate and drive the motor MG2.

The boost converter 55 is connected with the driving-voltage system power lines 54a which are connected with the inverters 41 and 42, and with battery-voltage system power lines 54b which are connected with the battery 54, and regulates the voltage of the driving-voltage system power lines 54a in a range between a voltage VL of the driving-voltage system power lines 54a and an allowable upper limit voltage VHmax, inclusive. The boost converter 55 is configured to include two transistors T31 and T32, two diodes D31 and D32 connected reversely in parallel to the transistors T31 and T32 and a reactor L1. The transistor T31 is connected with the positive bus bar of the driving-voltage system power lines 54a. The transistor T32 is connected with the transistor T31 and with the negative bus bars of the driving-voltage system power lines 54a and the battery-voltage system power lines 54b. The reactor L1 is connected with a junction point of the transistors T31 and T32 and with the positive bus bar of the battery-voltage system power lines 54b. The ratio of the on time of the transistors T31 and T32 is regulated by the motor ECU 40, so that the boost converter 55 boosts up the electric power of the battery-voltage system power lines 54b and supplies the boosted-up electric power to the driving-voltage system power lines 54a, while stepping down the electric power of the driving-voltage system power lines 54a and supplying the stepped-down electric power to the battery-voltage system power lines 54b. A smoothing capacitor 57 is mounted to the positive bus bar and the negative bus bar of the driving-voltage system power lines 54a, and a smoothing capacitor 58 is mounted to the positive bus bar and the negative bus bar of the battery-voltage system power lilies 54b.

The motor ECU 40 is implemented by a CPU-based microprocessor and includes a ROM that stores processing programs, a RAM that temporarily stores data, input and output ports and a communication port other than the CPU, although not being illustrated. As shown in FIG. 1, the motor ECU 40 inputs. via its input port, signals from various sensors required for drive control of the motors MG1 and MG2 and the boost converter 55. The signals input via the input port include, for example, rotational positions θm1 and θm2 of the rotors of the motors MG1 and MG2 from rotational position detection sensors 43 and 44 such as resolvers, phase currents Iu1, Iv1, Iu2 and Iv2 of the respective phases of the motors MG1 and MG2 from current sensors 45u, 45v, 46u and 46v, a voltage VH of the capacitor 57 from a voltage sensor 57a mounted between terminals of the capacitor 57 and a voltage VL of the capacitor 58 from a voltage sensor 58a mounted between the terminals of the capacitor 58, The voltage VH of the capacitor 57 corresponds to the voltage of the driving-voltage system power lines 54a, and the voltage VL of the capacitor 58 corresponds to the voltage of the battery-voltage system power lines 54b. The motor ECU 40 outputs, via its output port, for example, switching control signals to the transistors T11 to T16 of the inverter 41 and the transistors T21 to T26 of the inverter 42 and switching control signals to the transistors T31 and T32 of the boost converter 55. The motor ECU 40 is connected with the RVECU 70 via their communication ports to perform drive control of the motors MG1 and MG2 and the boost converter 55 in response to control signals from the HVECU 70 and output data regarding the driving conditions of the motors MG1 and MG2 and the boost converter 55 to the HVECU 70 as appropriate.

The battery 50 is configured, for example, as a lithium ion secondary battery or a nickel hydride secondary battery and is connected with the battery-voltage system power lines 54b as described above. The battery 50 is managed by a battery electronic control unit (hereinafter referred to as battery ECU) 52.

The battery ECU 52 is implemented by a CPU-based microprocessor and includes a ROM that stores processing programs, a RAM that temporarily stores data, input and output ports and a communication port other than the CPU, although not being illustrated. The battery ECU 52 inputs, via its input, port, signals required for management of the battery 50, for example, a battery voltage Vb from a voltage sensor located between terminals of the battery 50, a battery current Ib from a current sensor mounted to an output terminal of the battery 50, and a battery temperature Tb from a temperature sensor mounted to the battery 50. The battery ECU 52 is connected with the HVECU 70 via their communication ports to output data regarding the conditions of the battery 50 to the HVECU 70 as appropriate. With a view to managing the battery 50, the battery ECU 52 computes a state of charge SOC which denotes a ratio of the capacity of electric power dischargeable from the battery 50 to the entire capacity, based on an integrated value of the battery current Ib detected by the current sensor.

The system main relay 56 is provided on the battery 50-side of the capacitor 58 on the battery-voltage system power lines 54b.

The HVECU 70 is implemented by a CPU-based microprocessor and includes a ROM that stores processing programs, a RAM that temporarily stores data, input and output ports and a communication port other than the CPU, although not being illustrated. The HVECU 70 inputs, via its input port, for example, an ignition signal from an ignition switch 80, a shift position SP from a shift position sensor 82 configured to detect the operational position of a shift lever 81, an accelerator position Acc from an accelerator pedal position sensor 84 configured to detect the depression amount of an accelerator pedal 83, a brake pedal position BP from a brake pedal position sensor 86 configured to detect the depression amount of a brake pedal 85 and a vehicle speed V from a vehicle speed sensor 88. The HVECU 70 outputs, via its output port, for example, control signals to the system main relay 55. As described above, the HVECU 70 is connected with the engine ECU 24, the motor ECU 40 and the battery ECU 52 via their communication ports to transmit various control signals and data to and from the engine ECU 24, the motor ECO 40 and the battery ECU 52.

The hybrid vehicle 20 of the embodiment having the above configuration runs in a hybrid drive mode (HV drive mode) driven with operation of the engine 22 and in an electric drive mode (EV drive mode) driven with stop of operation of the engine 22.

During a run in the HV drive mode, the HVECU 70 first sets a required torque Tr* for driving (to be output to the driveshaft 36), based on the accelerator position Acc from the accelerator pedal position sensor 84 and the vehicle speed V from the vehicle speed sensor 88. The HVECU 70 subsequently multiplies the set required torque Tr* by a rotation speed Nr of the driveshaft 36 to calculate a driving power Pdrv* required for driving. A rotation speed Nm2 of the motor MG2 is used as the rotation speed Nr of the driveshaft 36. The HVECU 70 subtracts a required charge-discharge power Pb* of the battery 50 (positive value in the case of discharging from the battery 50) from the calculated driving power Pdrv* to set a required power Pe* for the vehicle (to be output from the engine 22). The HVECU 70 then sets a target rotation speed He* and a target torque Te* of the engine 22 and torque commands Tm1* and Tm2* of the motors MG1 and MG2 such as to cause the required power Pe* to be output from the engine 22 and cause the required torque Tr* to be output to the driveshaft 36. The HVECU 70 also sets a target voltage VH* of the driving-voltage system power lines 54a (capacitor 57) in a tendency to increase with increases in absolute values of the torque commands Tm1* and Tm2* of the motors MG1 and MG2 and absolute values of rotation speeds Nm1 and Nm2 of the motors MG1 and MG2. The HVECU 70 sends the target rotation speed Ne* and the target torque Te* of the engine 22 to the engine ECU 24, while sending the torque commands Tm1* and Tm2* of the motors MG1 and MG2 and the target voltage VH* of the driving-voltage system power lines 54a to the motor ECU 40. When receiving the target rotation speed Ne* and the target torque Te* of the engine 22, the engine ECU 24 performs intake air flow control, fuel injection control and ignition control of the engine 22 such as to operate the engine 22 based on the target rotation speed Ne* and the target torque Te*. When receiving the torque commands Tm1* and Tm2* of the motors MG1 and MG2 and the target voltage VH* of the driving-voltage system power lines 54a, the motor ECU 40 performs switching control of the transistors T11 to T16 of the inverter 41 and the transistors T21 to T26 of the inverter 42 to drive the motors MG1 and MG2 with the torque commands Tm1* and Tm2*, while performing switching control of the transistors T31 and T32 of the boost converter 55 to make the voltage VH of the driving-voltage system power lines 54a approach the target voltage VH*. Upon satisfaction of a stop condition of the engine 22 during a run in the HV drive mode, for example, when the required power Pe* becomes equal to or less than a stop threshold value Pstop, the hybrid vehicle 20 stops operation of the engine 22 and shifts the drive mode to the EV drive mode.

During a run in the EV drive mode, the HVECU 70 first sets the required torque Tr*, based on the accelerator position Acc from the accelerator pedal position sensor 84 and the vehicle speed V from the vehicle speed sensor 38. The HVECU 70 subsequently sets the torque command Tm1* of the motor MG1 to value 0 and sets the torque command Tm2* such as to cause the required torque Tr* to be output to the driveshaft 36. The HVECU 70 also sets the target voltage VH* of the driving-voltage system power lines 54a (capacitor 57), based on the absolute values of the torque commands Tm1* and Tm2* of the motors MG1 and MG2 and the absolute values of the rotation speeds Nm1 and Nm2 of the motors MG1 and MG2. The HVECU 70 then sends the torque commands Tm1* and Tm2* of the motors MG1 and MG2 and the target voltage VH* of the driving-voltage system power lines 54a to the motor ECU 40. When receiving the torque commands Tm1* and Tm2* of the motors MG1 and MG2 and the target voltage VH* of the driving-voltage system power lines 54a, the motor ECU 40 performs switching control of the transistors T11 to T16 of the inverter 41 and the transistors T21 to T26 of the inverter 42 to drive the motors MG1 and MG2 with the torque commands Tm1* and Tm2*, while performing switching control of the transistors T31 and T32 of the boost converter 55 to make the voltage VH of the driving-voltage system power lines 54a approach the target voltage VH*. Upon satisfaction of a restart condition of the engine 22 during a run in the EV drive mode, for example, when the required power Pe* calculated in the same manner as that during a run in the HV drive mode becomes larger than the stop threshold value Pstop, the hybrid vehicle 20 restarts operation of the engine 22 and shifts the drive mode to the HV drive mode.

A basic procedure of starting the engine 22 cranks the engine 22 by outputting a cranking torque for cranking the engine 22 from the motor MG1 while outputting a cancellation torque for cancelling a torque applied to the driveshaft 36 accompanied with output of this cranking torque from the motor MG2, and starts operation control (fuel injection control and ignition control) of the engine 22 when the rotation speed Ne of the engine 22 reaches or exceeds a predetermined rotation speed (for example, 800 rpm or 1000 rpm). During the start of the engine 22, drive control of the motor MG2 is performed to cause the required torque Tr* to be output to the driveshaft 36. In other words, the torque to be output from the motor MG2 is a total torque of the required torque Tr* and the cancellation, torque.

In the case where an abnormality occurs in the boost converter 55 or the battery 50 in the HV drive mode or in the EV drive mode, the hybrid vehicle 20 of the embodiment controls the engine 22, the inverters 41 and 42 and the boost converter 55 as described below. The hybrid vehicle 20 causes self-sustaining operation of the engine 22 in the HV drive mode, while continuing stop of operation of the engine 22 in the EV drive mode. The hybrid vehicle 20 shuts off the gates of the inverters 41 and 42 and the boost converter 55 (i.e., turns off all the transistors T11 to T16, T21 to T26, T31 and T32). In this state, the system main relay 56 is turned off to disconnect the boost converter 55-side from the battery 50-side. In the description below the state of disconnecting the boost converter 55-side from the battery 50-side by the system main relay 56 is called battery-less state.

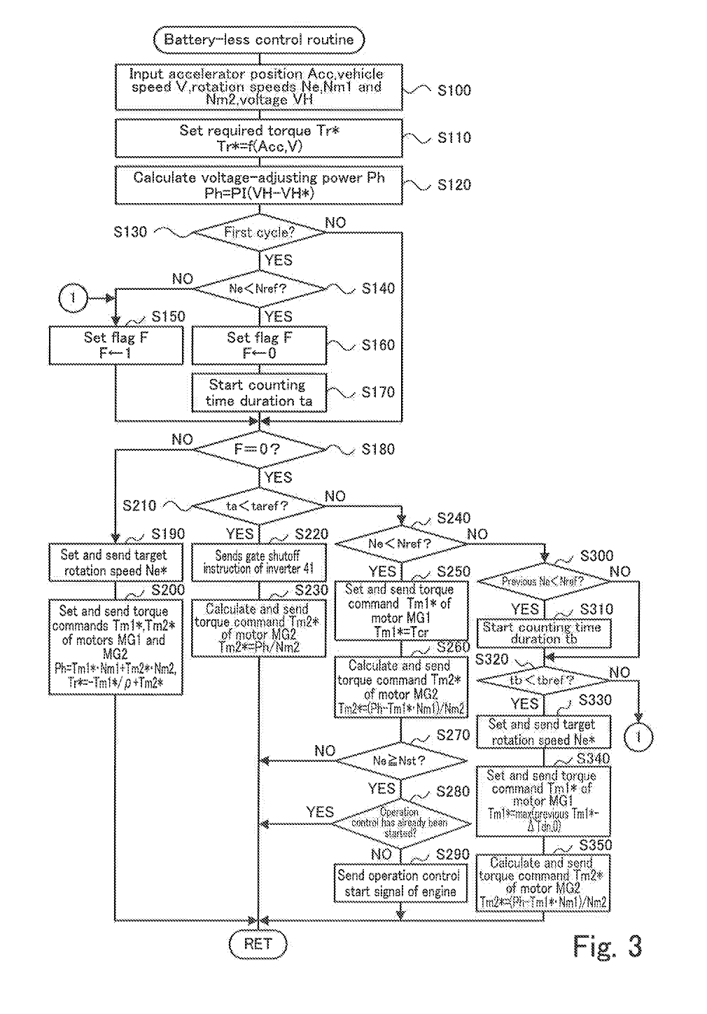

The following describes the operations of the hybrid vehicle 20 of the embodiment having the above configuration or more specifically the operations in a battery-less state. FIG. 3 is a flowchart showing one example of battery-less control routine performed by an HVECU 70 according to the embodiment. This routine is repeatedly performed at predetermined time intervals (for example, every several msec) in the battery-less state.

On start of the battery-less control routine, the HVECU 70 first inputs data such as the accelerator position Acc, the vehicle speed V, the rotation speed Ne of the engine 22, the rotation speeds Nm1 and Nm2 of the motors MG1 and MG2 and the voltage VH of the driving-voltage system power lines 54a (capacitor 57) (step S100). The input accelerator position Acc is a value detected by the accelerator pedal position sensor 84. The input vehicle speed V is a value detected by the vehicle speed sensor 88. The input rotation speed Ne of the engine 22 is a calculated value from the crank position θcr detected by the crank position sensor 23. The rotation speeds Nm1 and Nm2 of the motors MG1 and MG2 are computed based on the rotational positions θm1 and θm2 of the rotors of the motors MG1 and MG2 detected by the rotational position detection sensors 43 and 44 and are input from the motor ECU 40 by communication. The voltage VH of the driving-voltage system power lines 54a (capacitor 57) is detected by the voltage sensor 57a and is input from the motor ECU 40 by communication.

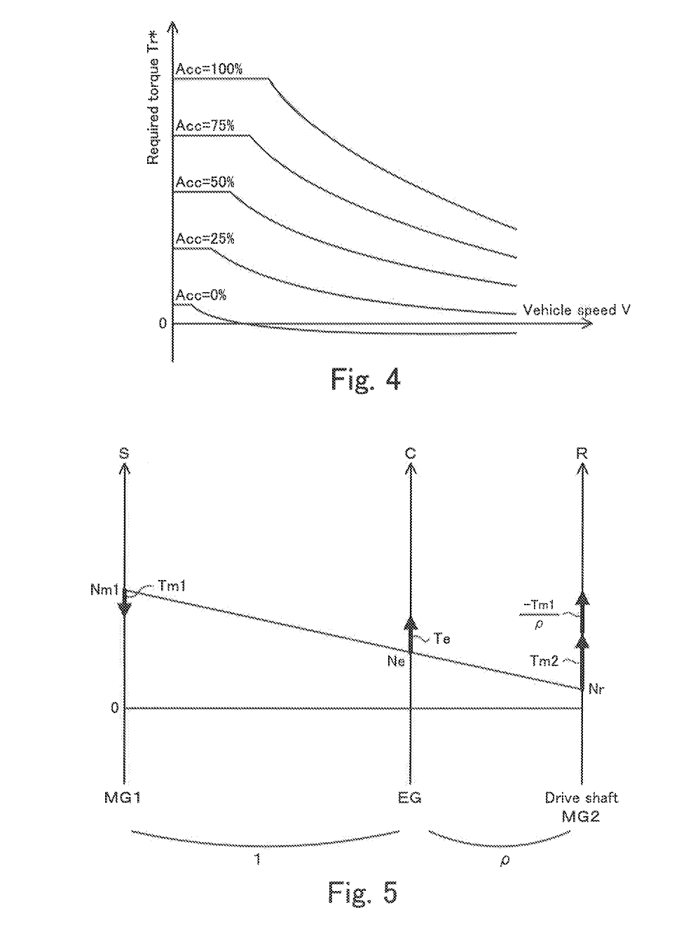

After the data input, the HVECU 70 sets a required torque Tr* for driving, based on the input accelerator position Acc and the input vehicle speed V (step S110). A procedure of setting the required torque Tr* according to the embodiment stores predefined relationship between the vehicle speed V and the required torque Tr* at different accelerator positions Acc as a required torque setting map in the ROM (not shown), and reads and sets the required torque Tr* corresponding to the given accelerator position Acc and the given vehicle speed V from the stored map. One example of the required torque setting map is shown in FIG. 4.

The HVECU 70 subsequently uses the voltage VH and the target voltage VH* of the driving-voltage system power lines 54a (capacitor 57) to calculate a voltage-adjusting power Ph according to Equation (1) given below (step S120). The target voltage VH* of the driving-voltage system power lines 54a may be, for example, 450 V, 500 V or 550 V when the allowable upper limit voltage VHmax is 650 V. Such setting is for the purpose of satisfying both the condition that performs drive control of the motors MG1 and MG2 such as to enable a torque of relatively large absolute value to be output from the motors MG1 and MG2 and the condition that suppresses the voltage VH of the driving-voltage system power lines 54a from exceeding the allowable upper limit voltage VHmax. Equation (1) is a relational expression of feedback control to make the voltage VH of the driving-voltage system power lines 54a approach the target voltage VH*. In Equation (1), “kp” in the first terra of the right side is a gain of proportional, and “ki” in the second term of the right side is a gain of integral term.

Ph=kp·(VH−VH*)+ki*·∫(VH−VK*)dt (1)

The HVECU 70 subsequently determines whether the current time is a first cycle of this routine (immediately after a shift to the battery-less state) (step S130). When it is determined that the current time is the first cycle of this routine, the HVECU 70 compares the rotation speed Ne of the engine 22 with a reference value Nref (step S140). When the rotation speed Ne of the engine 22 is equal to or higher than the reference value Nref, the HVECU 70 sets a flag F to value 1 (step S150). When the rotation speed Ne of the engine 22 is lower than the reference value Nref, on the other hand, the HVECU 70 sets the flag F to value 0 (step S160) and starts counting a time duration ta since the first cycle of this routine (step S170). The reference value Nref is used to determine whether the engine 22 is rotated at a certain level of rotation speed and may be, for example, 700 rpm or 800 rpm. When it is determined at step S130 that the current time is not the first cycle of this routine but is a second or subsequent cycle of this routine, on the other hand, the HVECU 70 skips the processing of steps S140 to S170. In the case of a shift to the battery-less state during operation of the engine 22, the rotation speed Ne of the engine 22 is equal to or higher than the reference value Nref, and the flag F is set to the value 1. In the case of a shift to the battery-less state during stop of operation of the engine 22, on the other hand, the rotation speed Ne of the engine 22 is lower than the reference value Nref, and the flag F is set to the value 0.

The HVECU 70 subsequently checks the setting of the flag F (step S180). When the flag F is equal to the value 1, the HVECU 70 sets a target rotation speed Ne* of the engine 22 and sends the target rotation speed Ne* to the engine ECU 24 (step S190). When receiving the target rotation speed Ne* of the engine 22, the engine ECU 24 performs intake air flow control, fuel injection control and ignition control of the engine 22 such as to rotate the engine 22 at the target rotation speed Ne*. According to this embodiment, the target rotation speed Ne* of the engine 22 is set in a tendency to increase with an increase in accelerator position Acc and increase with an increase in vehicle speed V. The target rotation speed Ne* may alternatively be set to a fixed rotation speed.

The HVECU 70 sets torque commands Tm1* and Tm2* of the motors MG1 and MG2 in order to satisfy both Equations (2) and (3) given below and sends the set torque commands Tm1* and Tm2* to the motor ECU 40 (step S200). This routine is then terminated. When receiving the torque commands Tm1* and Tm2* of the motors MG1 and MG2, the motor ECU 40 performs switching control of the transistors T11 to T16 of the inverter 41 and the transistors T21 to T26 of the inverter 42 to drive the motors MG1 and MG2 with the torque commands Tm1* and Tm2*. Equation (2) shows the relationship that the sum of an electric power Pm1 (=Tm1*·Nm1) of the motor MG1 and an electric power Pm2 (=Tm2*·Nm2) of the motor MG2 is equal to the voltage-adjusting poller Ph. The electric powers Pm1 and Pm2 of the motors MG1 and MG2 denote power consumption in the case of positive values and denote power generation in the case of negative values. Equation (3) shows the relationship that the sum of a torque (−Tm1*/ρ) output from the motor MGI to the driveshaft 36 via the planetary gear 30 and a torque Tm2* output from the motor MG2 to the driveshaft 36 is equal to the required torque Tr*.

Ph=Tm1*·Nm1+Tm2*·Nm2 (2)

Tr*=Tm1*/ρ+Tm2* (3)

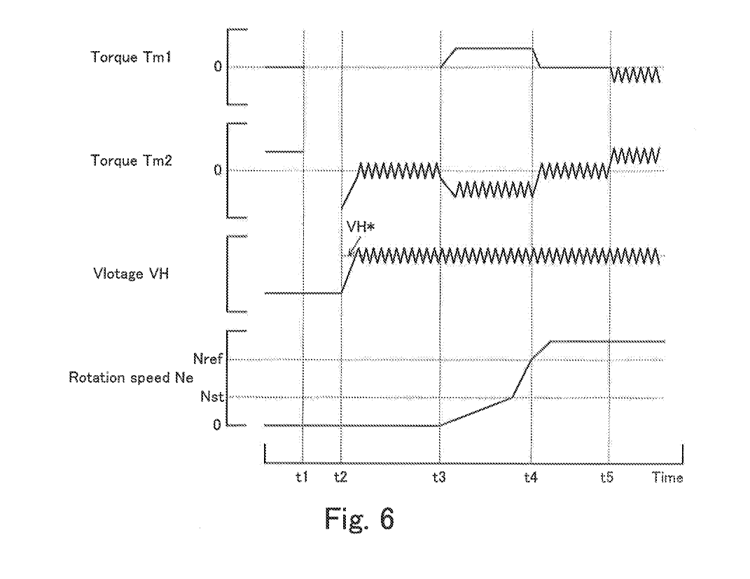

FIG. 5 is a collinear diagram illustrating one example of dynamic relationship between rotation speed and torque with regard to the rotational elements of the planetary gear 30. In the diagram, S axis on the left indicates the rotation speed of the sun gear that is equivalent to the rotation speed Nm1 of the motor MG1, C axis in the middle indicates the rotation speed of the carrier that is equivalent to the rotation speed Ne of the engine 22, and R axis on the right indicates the rotation speed Nr of the ring gear (driveshaft 36) that is equivalent to the rotation speed Nm2 of the motor MG2. Equation (3) is readily introduced from this collinear diagram. Two thick arrows on the R axis represent a torque output from the motor MG1 and applied to the driveshaft 36 via the planetary gear 30 and a torque output from the motor MG2 and applied to the driveshaft 36. In this case, a torque in a direction of reducing the rotation speed Ne of the engine 22 is output from the motor MG1, so that the engine 22 is operated to rotate at the target rotation speed Ne* and output a torque according to the torque output from the motor MG1 and a gear ratio ρ of the planetary gear 30. In the case of a shift to the battery-less state during operation of the engine 22, such control of the engine 22 and the inverters 41 and 42 causes the voltage VH of the driving voltage-system power lines 54a to be varied in the range close to the target voltage VH* and enables the hybrid vehicle 20 to be driven with the required torque Tr*.

When the flag F is equal to the value 0 at step S180, on the other hand, the HVECU 70 compares the time duration ta with a predetermined reference time duration taref (step S210). The reference time duration taref may be, for example, 2 seconds or 3 seconds. The reference time duration taref will be describe d later in detail.

When the time duration ta is shorter than the predetermined reference time duration taref, the HVECU 70 sends a gate shut off instruction of the inverter 41 to the motor ECU 40 (step S220). The HVECU 70 subsequently divides the voltage-adjusting power Ph by the rotation speed Nm2 of the motor MG2 to calculate a torque command Tm2* of the motor MG2 and sends the calculated torque command Tm2* to the motor ECU 40 (step S230). This routine is then terminated. When receiving the gate shutoff instruction of the inverter 41 and the torque command Tm2* of the motor MG2, the motor ECU 40 shuts off the gates of the inverters 41 (i.e., turns off all the transistors T11 to T16) and performs switching control of the transistors T21 to T26 of the inverter 42 such as to drive the motor MG2 with the torque command Tm2*. In the case of a shift to the battery-less state during stop of operation of the engine 22, when the time duration ta is shorter than the predetermined reference time duration taref, such control of the inverters 41 and 42 enables the voltage VH of the driving-voltage system power lines 54a to approach the target voltage VH*. In this case, a torque corresponding to the voltage-adjusting power Ph is output from the motor MG2 to the driveshaft 36 irrespective of the required torque Tr*. The reference time duration taref may be determined in advance by experiment or by analysis as a time duration required to stabilize the driving-voltage system power lines 54a at a level close to the target voltage VH* since the first cycle of this routine or a time duration slightly longer than the required time duration.

When the time duration ta is equal to or longer than the predetermined reference time duration taref at step S210, on the other hand, the HVECU 70 compares the rotation speed Ne of the engine 22 with the reference value Nref described above (step S240). When the rotation speed Ne of the engine 22 is lower than the reference value Nref, the HVECU 70 sets a torque command Tm1* of the motor MGI to a cranking torque Tor for cranking the engine 22 and sends the torque command Tm1* of the motor MG1 to the motor ECU 40 (step S250). According to this embodiment, the cranking torque Tcr is varied from value 0 to a relatively large predefined value Tcr1 by the rating process using a rating value ΔTcr and is kept at the predefined value Tcr1 as shown by Equation (4) given below. The HVECU 70 subsequently sets a torque command Tm2* of the motor MG2 by subtracting the electric power Pm1 of the motor MG1, which is obtained by multiplying the torque command Tm1* of the motor MG1 by the rotation speed Nm1, from the voltage-adjusting power Ph and dividing the result of subtraction by the rotation speed Nm2 of the motor MG2 according to Equation (5) given below and sends the set torque command Tm2* of the motor MG2 to the motor ECU 40 (step S260). When receiving the torque commands Tm1* and Tm2* of the motors MG1 and MG2, the motor ECU 40 performs switching control of the transistors T11 to T16 of the inverter 41 and the transistors T21 to T26 of the inverter 42 to drive the motors MG1 and MG2 with the torque commands Tm1* and Tm2*. In the case of a shift to the battery-less state during stop of operation of the engine 22, when the time duration ta is equal to or longer than the predetermined reference time duration taref and the rotation speed Ne of the engine 22 is lower than the reference value Nref, such control of the inverters 41 and 42 enables the engine 22 to be cranked by the motor MG1, while causing the voltage HV of the driving-voltage system power lines 54a to be varied in the range close to the target voltage VH*.

Tcr=min(previous Tcr+ΔTcr, Tcr1) (4)

Tm2*=(Ph−Tm1*·Nm1)/Nm2 (5)

The HVECU 70 subsequently compares the rotation speed Ne of the engine 22 with a predetermined threshold value Nst that is lower than the reference value Nref described above (step S270). The threshold value Nst is determined in advance by experiment or by analysis as a minimum rotation speed than allows the rotation speed Ne of the engine 22 to be increased to or above the reference value Nref described above by starting operation control (fuel injection control and ignition control) of the engine 22 or a slightly higher rotation speed than the minimum rotation speed and may be, for example, 200 rpm or 300 rpm.

When the rotation speed Ne of the engine 22 is lower than the threshold value Nst, the HVECU 70 terminates this routine. When the rotation speed Ne of the engine 22 is equal to or higher than the threshold value Nst, on the other hand, the HVECU 70 determines whether operation control of the engine 22 has already been started (step S280). When the operation control of the engine 22 has not yet been started, the HVECU 70 sends an operation control start signal of the engine 22 to the engine ECU 24 (step S290) and terminates this routine. When the operation control of the engine 22 has already been started, the HVECU 70 terminates this routine. When receiving the operation control start signal of the engine 22, the engine ECU 24 starts fuel injection control and ignition control of the engine 22. Starting the operation control of the engine 22 enables the rotation speed Ne of the engine 22 to be increased to or above the reference value Nref by the cranking torque Tcr from the motor MGI and the torque from the engine 22.

When the rotation speed Ne of the engine 22 is equal to or higher than the reference value Nref at step S240, on the other hand, the HVECU 70 compares a previous rotation speed (previous Ne) of the engine 22 with the reference value Nref (step S300). This process determines whether the current time is immediately after the time when the rotation speed Ne of the engine 22 reaches or exceeds the reference value Nref.

When the previous rotation speed (previous Ne) of the engine 22 is lower than the reference value Nref, it is determined that the current time is immediately after the time when the rotation speed Ne of the engine 22 reaches or exceeds the reference value Nref. The HVECU 70 then starts counting a time duration tb since the time when the rotation speed Ne of the engine 22 reaches or exceeds the reference value Nref (step S310). When the previous rotation speed (previous Ne) of the engine 22 is equal to or higher than the reference value Nref, on the other hand, it is determined that the current time is not immediately after the time when the rotation speed Ne of the engine 22 reaches or exceeds the reference value Nref. The HVECU 70 then skips the processing of step S310.

The HVECU 70 subsequently compares the time duration Tb with a predetermined reference time duration tbref (step S320). The reference time duration tbref may be, for example, 2 seconds or 3 seconds. The reference time duration tbref will be described later in detail.

When the time duration tb is shorter than the predetermined reference time duration tbref at step S320, the HVECU 70 sets a target rotation speed. Ne* of the engine 22 and sends the set target rotation speed Ne* to the engine ECU 24 (step S330). When receiving the target rotation speed Ne* of the engine 22, the engine ECU 24 performs intake air flow control, fuel injection control and ignition control of the engine 22 such as to rotate the engine 22 at the target rotation speed Ne*. According to this embodiment, the target rotation speed Ne* of the engine 22 is set in a tendency to increase with an increase in accelerator position Acc and increase with an increase in vehicle speed V. The target rotation speed Ne* may alternatively be set to a fixed rotation speed.

The HVECU 70 subsequently sets a torque command Tm1* of the motor MG1 and sends the set torque command Tm1* of the motor MG1 to the motor ECU 40 (step S340). According to this embodiment, the torque command Tm1* of the motor MG1 is varied from the predefined value Tcr1 to the value 0 by the rating process using a rating value ΔTdn and is kept at the value 0 as shown by Equation (6) given below. The HVECU 70 calculates a torque command Tm2* of the motor MG2 as shown by Equation (5) given above and sends the calculated torque command Tm2* of the motor MG2 to the motor ECU 40 (step S350). This routine is then terminated. When receiving the torque commands Tm1* and Tm2* of the motors MG1 and MG2, the motor ECU 40 performs switching control of the transistors T11 to T16 of the inverter 41 and the transistors T21 to T26 of the inverter 42 to drive the motors MG1 and MG2 with the torque commands Tm1* and Tm2*. In the case of a shift to the battery-less state during stop of operation of the engine 22, when the time duration ta is equal to or longer than the predetermined reference time duration taref, the rotation speed Ne of the engine 22 is equal to or higher than the reference value Nref, and the time duration tb is shorter than the predetermined reference time duration tbref, such control of the engine 22 and the inverters 41 and 42 sets the torque command Tm1* of the motor MG1 to the value 0, while causing the voltage VH of the driving-voltage system power lines 54a to be varied in the range close to the target voltage VH*. The reference time duration tbref may be determined in advance by experiment or by analysis as a time duration required to stabilize the voltage VH of the driving-voltage system power lines 54a at a level close to the target voltage VH* in the state that the torque of the motor MG1 is equal to the value 0 since the time when the rotation speed Me of the engine 22 reaches or exceeds the reference value Nref or a time duration slightly-longer than the required time duration.

Tm1*=max(previous Tm1*−ΔTdn, 0) (6)

When the time duration tb is equal to or longer than the predetermined reference time duration tbref at step S320, the HVECU 70 sets the flag F to the value 1 (step S150). In this case, it is determined that the flag F is equal to the value 1 at step S180. The KVECU 70 then performs the processing of steps S190 and S200 and terminates this routine. As in the case of a shift to the battery-less state in the HV drive mode, this enables the hybrid vehicle 20 to be driven with the required torque Tr*, while causing the voltage VK of the driving-voltage system power lines 54a to be varied in the range close to the target voltage VH*. Performing the processing of steps S1S0 to S200 after setting the torque of the motor MG1 to the value 0 allows for a smooth change in torque of the motor MG1. In the case that the flag F is set to the value 1, it is determined at step S180 that the flag F is equal to the value 1 in a subsequent cycle of this routine. The HVECU 70 accordingly performs the processing of steps S190 and S200 and terminates the subsequent cycle of this routine.

FIG. 6 is a diagram schematically illustrating time changes of the torques Tm1 and Tm2 of the motors MG1 and MG2 and the voltage VH of the driving-voltage system power lines 54a in the case of a shift to the battery-less state in the EV drive mode (during stop of operation of the engine 22). As illustrated, when an abnormality occurs in the boost converter 55 or the battery 50 in the EV drive mode (at time t1), the hybrid vehicle 20 continues stop of operation of the engine 22, shuts off the gates of the inverters 41 and 42 and the boost converter 55 and turns off the system main relay 56 to shift to the battery-less state (at time t2).

In the case of a shift to the battery-less state, the hybrid vehicle 20 continues the gate shutoff of the inverter 41 and causes a torque (Ph/Nm2) to be output from the motor MG2 (steps S220 and S230 in the routine of FIG. 3). Hereinafter this control is referred to as specified preparatory control, Performing the specified preparatory control causes the voltage VH of the driving-voltage system power lines 54a to approach the target voltage VH* and to be varied in the range close to the target voltage VH*. After elapse of the predetermined reference time duration taref described above since the time t2 (at time t3), the hybrid vehicle 20 causes the cranking torque Tcr to be output from the motor MG1 while causing a torque (Ph−Tm1*·Nm1)/Nm2 to be output from the motor MG2 (steps S250 and S260), and starts the operation control of the engine 22 when the rotation speed Ne of the engine 22 reaches or exceeds the threshold value Nst (steps S270 to S230). Hereinafter this control is referred to as specified start control. Performing the specified start control causes the engine 22 to be cranked and started by the motor MG1, while causing the voltage VH of the driving-voltage system power lines 54a to be varied in the range close to the target voltage VH*. Performing the specified start control after performing the specified preparatory control suppresses a variation in voltage VH of the driving-voltage system power lines 54a during a start of the engine 22 and thereby allows for a smooth start of the engine 22.

When the rotation speed Ne of the engine 22 reaches or exceeds the reference value Nref (at time t4), the hybrid vehicle 20 sets the torque of the motor MG1 to the value 0 and causes a torque (Ph/Nm2) to be output from the motor MG2, while operating the engine 22 to be rotated at the target rotation speed Ne* (steps S330 to S350). Hereinafter this control is referred to as specified standby control. After elapse of the predetermined reference time duration tbref since the time t4 (at time t5), the hybrid vehicle 20 outputs the torques Tm1 and Tm2 from the motors MG1 and MG2 to make the sum of the electric powers Pm1 and Pm2 of the motors MG1 and MG2 equal to the voltage-adjusting power Ph and cause the required torque Tr* to be output to the driveshaft 36, while operating the engine 22 to be rotated at the target rotation speed Ne* (steps S190 and S220). Hereinafter this control is referred to as specified drive control. Performing the specified drive control enables the hybrid vehicle 20 to be driven with the required torque Tr*, while causing the voltage VH of the driving-voltage system power lines 54a to be varied in the range close to the target voltage VH*. Performing the specified drive control after performing the specified standby control allows for a smooth change in torque Tm1 of the motor MG1.

The hybrid vehicle 20 of the embodiment described above performs the specified start control, when the system main relay 56 is turned off during stop of operation of the engine 22. The specified start control herein controls the engine 22 and the motor MG1 to cause the engine 22 to be cranked and starred by the motor MG1, while controlling the motor MG2 to make the voltage VH of the driving-voltage system power lines 54a approach the target voltage VH*. This enables the engine 22 to be cranked and started by the motor MG1, while causing the voltage VH of the driving-voltage system power lines 54a to be varied in the range close to the target voltage VH*.

The hybrid vehicle 20 of the embodiment performs the specified drive control after starting the engine 22 by the specified start control. The specified drive control herein controls the engine 22 to be rotated at the target rotation speed Ne*, while controlling the motors MG1 and MG2 to make the voltage VH of the driving-voltage system power lines 54a approach the target voltage VH* and enable the hybrid vehicle 20 to be driven with the required torque Tr*. This enables the hybrid vehicle 20 to be driven with the required torque Tr*, while causing the voltage VH of the driving-voltage system power lines 54a to be varied in the range close to the target voltage VH*. In this case, the hybrid vehicle 20 sequentially performs the specified standby control and the specified drive control after starting the engine 22 by the specified start control. The specified standby control herein controls the engine 22 to be rotated at the target rotation speed Ne*, while controlling the motor MG1 to have torque set equal to the value 0 and controlling the motor MG2 to make the voltage VH of the driving-voltage system power lines 54a approach the target voltage VH*. This allows for a smooth change in torque Tm1 of the motor MG1.

Additionally, when the system main relay 56 is turned off during stop of operation of the engine 22, the hybrid vehicle 20 of the embodiment performs the specified preparatory control prior to the specified start control. The specified preparatory control herein shuts off the gates of the inverter 41, while controlling the motor MG2 to make the voltage VH of the driving-voltage system power lines 54a approach the target voltage VH*. This suppresses a variation in voltage VH of the driving-voltage system power lines 54a, while the engine 22 is cranked and started by the motor MG1.

When the system main relay 56 is turned off during stop of operation of the engine 22, the hybrid vehicle 20 of the embodiment sequentially performs the specified standby-control and the specified drive control after starting the engine 22 by the specified start control. One modification may perform the specified drive control without performing the specified standby control.

When the system main relay 56 is turned off during stop of operation of the engine 22, the hybrid vehicle 20 of the embodiment performs the specified preparatory control prior to the specified start control. One modification may perform the specified start control without performing the specified preparatory control.

When the system main relay 56 is turned off during stop of operation of the engine 22, the hybrid vehicle 20 of the embodiment performs the specified preparatory control and the specified start control irrespective of the vehicle speed V. One modification may make the hybrid vehicle ready-off when the vehicle speed V is higher than a predetermined reference value Vref. The reference value Vref may be, for example, 20 km/h or 30 km/h.

The hybrid vehicle 20 of the embodiment includes the boost converter 55. One modification may omit the boost converter 55.

In the hybrid vehicle of the above aspect, the specified start control performed by the controller may control the second motor to output a power according to a power of cancelling a difference between the voltage of the capacitor and the target voltage and a power of the first motor.

Further, in the hybrid vehicle of the above aspect, the specified start control performed by the controller may set torque commands of the first motor and the second motor without considering the required torque and control the first motor and the second motor.

Furthermore, in the hybrid vehicle of the above aspect, after performing the specified start control to start the engine, the controller may perform specified drive control that controls the engine to be rotated at a target rotation speed, while controlling the first motor and the second motor to make the voltage of the capacitor approach the target voltage and to enable the hybrid vehicle to be driven with the required torque. This enables the hybrid vehicle to be driven with the required torque, while causing the voltage of the capacitor to be varied in a range close to the target voltage.

In the hybrid vehicle of the above aspect that performs the specified drive control after performing the specified start control to start the engine, after performing the specified start control to start the engine, the controller may perform specified standby control prior to the specified drive control. The specified standby control controls the engine to be rotated at the target rotation speed, while controlling the first motor to set a torque output from the first motor equal to value 0 and controlling the second motor to make the voltage of the capacitor approach the target voltage. This allows for a smooth change in torque from the first motor.

In the hybrid vehicle of the above aspect, in the battery-less state during stop of operation of the engine, the controller may perform specified preparatory control prior to the specified start control. The specified preparatory control controls the second motor to make the voltage of the capacitor approach the target voltage. This enables the hybrid vehicle to perform the specified start control after causing the voltage of the capacitor to be close to the target voltage. This suppresses a variation in voltage of the capacitor during a start of the engine and allows for a smooth start of the engine.

The following describes the correspondence relationship between the primary components of the embodiment and the primary components of the invention described in Summary of Invention. The engine 22 of the embodiment corresponds to the “engine”; the motor MG1 corresponds to the “first motor”; the planetary gear 30 corresponds to the “planetary gear”; and the motor MG2 corresponds to the “second motor”. The battery 50 corresponds to the “battery”; the capacitor 57 corresponds to the “capacitor”; and the system main relay 56 corresponds to the “relay”. The HVECU 70 performing the battery-less control routine of FIG. 3, the engine ECU 24 controlling the engine 22 in response to an instruction from the HVECU 70 and the motor ECU 40 controlling the inverters 41 and 42 in response to an instruction from the HVECU 70 correspond to the “controller”.

The correspondence relationship between the primary components of the embodiment and the primary components of the invention, regarding which the problem is described in Summary of Invention, should not be considered to limit the components of the invention, regarding which the problem is described in Summary of Invention, since the embodiment is only illustrative to specifically describes the aspects of the invention, regarding which the problem is described in Summary of Invention. In other words, the invention, regarding which the problem is described in Summary of Invention, should be interpreted on the basis of the description in the Summary of Invention, and the embodiment is only a specific example of the invention, regarding which the problem is described in Summary of Invention.

The aspect of the invention is described above with reference to the embodiment. The invention is, however, not limited to the above embodiment but various modifications and variations may be made to the embodiment without departing from the scope of the invention.

The disclosure of Japanese Patent Application No. 2014-244474 filed Dec. 2, 2014 including specification, drawings and claims is incorporated herein by reference in its entirety.

### INDUSTRIAL APPLICABILITY

The technique of the invention is preferably applicable to the manufacturing industries of hybrid vehicle.

### CITATION LIST

### Patent Literature

PTL 1: JP 2012-153221 A

1. A hybrid vehicle, comprising
an engine;
a first motor that is configured to input and output power;
a planetary gear that is configured to have three rotational elements connected with a rotating shaft of the first motor, an output shaft of the engine and a driveshaft linked with drive wheels such that the rotating shaft, the output shaft and the drive shaft are arrayed in this sequence on a collinear diagram;
a second motor that is configured to input and output power to and from the driveshaft;
a battery;
a capacitor that is mounted to power lines connecting the first motor and the second motor with the battery;
a relay that is provided on a battery side of the capacitor on the power lines; and
a controller that is configured to control the engine, the first motor and the second motor such that the hybrid vehicle is driven with a required torque in a state that the first motor and the second motor are connected with the battery by the relay, wherein
in a battery-less state that the first motor and the second motor are disconnected from the battery by the relay during stop of operation of the engine, the controller performs specified start control than controls the engine and the first motor to cause the engine to be cranked and started by the first motor, while controlling the second motor to make a voltage of the capacitor approach a target voltage.

2. The hybrid vehicle according to claim 1,
wherein the specified start control performed by the controller controls the second motor to output a power according to a power of cancelling a difference between the voltage of the capacitor and the target voltage and a power of the first motor.

3. The hybrid vehicle according to claim 1,
wherein the specified start control performed by the controller sets torque commands of the first motor and the second motor without considering the required torque and controls the first motor and the second motor.

4. The hybrid vehicle according to claim 2,
wherein the specified start control performed by the controller sets torque commands of the first motor and the second motor without considering the required torque and controls the first motor and the second motor.

5. The hybrid vehicle according to claim 1,
wherein after performing the specified start control to start the engine, the controller performs specified drive control that controls the engine to be rotated at a target rotation speed, while controlling the first motor and the second motor to make the voltage of the capacitor approach the target voltage and to enable the hybrid vehicle to be driven with the required torque.

6. The hybrid vehicle according to claim 5,
wherein after performing the specified start control to start the engine, the controller performs specified standby control prior to the specified drive control, wherein the specified standby control controls the engine to be rotated at the target rotation speed, while controlling the first motor to set a torque output from the first motor equal to value 0 sold controlling the second motor to make the voltage of the capacitor approach the target voltage.

7. The hybrid vehicle according to claim 1,
wherein in the battery-less state during stop of operation of the engine, the controller performs specified preparatory control prior to the specified start control, wherein the specified preparatory control controls the second motor to make the voltage of the capacitor approach the target voltage.
